(19) United States
(12) Patent Application Publication
(10) Pub. No.: US 2016/0018070 A1
(43) Pub. Date: Jan. 21, 2016

(54) COMPACT LIGHTING DEVICE

(71) Applicant: INTERNATIONAL DEVELOPMENT LLC, ROANOKE, TX (US)

(72) Inventors: GARY VAN DEURSEN, ESSEX, CT (US); BRIAN E. HARRIS, FORT WORTH, TX (US)

(73) Assignee: INTERNATIONAL DEVELOPMENT LLC, ROANOKE, TX (US)

(21) Appl. No.: 14/772,727

(22) PCT Filed: Mar. 6, 2014
(86) PCT No.: PCT/US14/21177

§ 371 Date: Sep. 3, 2015

Related U.S. Application Data
(60) Provisional application No. 61/773,591, filed on Mar. 6, 2013.

(51) Int. Cl. F21L 4/00; F21V 23/04; F21V 23/00; F21V 21/096

(52) U.S. Cl. CPC F21L 4/00; F21V 21/096; F21V 23/0414; F21V 23/002; F21Y 2101/02

(57) ABSTRACT

A compact lighting device includes a battery-powered light emitting element and a housing that can be magnetically attached to a ferrous metal object, such as a hand tool. The housing and/or magnet can be provided with a longitudinal groove that causes the lighting device to automatically self-align with any cylindrical object to which it may be attached. The housing can have a switch extending therefrom to allow a user to activate and deactivate the light emitting element. Alternatively, the light emitting element can be turned on and off by moving the housing relative to the magnet.

This application claims the benefit of U.S. Provisional Application No. 61/773,591, filed 6 Mar. 2013, which is hereby incorporated herein by reference.

### TECHNICAL FIELD

The present disclosure relates to compact light sources, including those that include a light emitting diode and a magnet for holding the light source in place.

### SUMMARY

According to some aspects of the present disclosure, a lighting device comprises a housing, a battery disposed within the housing, a light emitting element supported by the housing, and a switch operable by a user for opening and closing an electrical current path between the battery and the light emitting element. The switch can include a magnet supported by the housing, where the magnet is moveable between a first position where the electrical current path is open and a second position where the electrical current path is closed.

In some embodiments, the lighting device can further include a battery housing that at least partially surrounds the battery within the housing. In some embodiments, the lighting device can further include a resistor disposed within the housing and electrically connected between the battery and the light emitting element. In some embodiments, the light emitting element can include a light emitting diode.

In some embodiments, the switch can further include a carriage attached to the magnet between the magnet and the battery and an electrical conductor attached to the carriage between the carriage and the battery. In some such embodiments, the electrical conductor can provide a portion of the electrical current path between the battery and the light emitting element when the magnet is in the second position.

In some embodiments, the switch can further include an electrical conductor attached to the magnet between the magnet and the battery. In some such embodiments, the electrical conductor can provide a portion of the electrical current path between the battery and the light emitting element when the magnet is in the second position.

In some embodiments, the lighting device further comprises a first electrical conductor that is electrically connected to the light emitting element, and the switch further comprises a second electrical conductor that is fixed to the magnet, where the first electrical conductor extends between the second electrical conductor and the magnet when the magnet is in the second position.

In some embodiments, the lighting device further comprises a first electrical conductor that is electrically connected to the light emitting element and an electrical contact that is electrically connected to the battery, where the first electrical conductor has a lower surface that is substantially coplanar with a lower surface of the electrical contact. In some such embodiments, the switch can further comprise a second electrical conductor that is fixed to the magnet, where the second electrical conductor can provide a portion of the electrical current path between the battery and the light emitting element when the magnet is in the second position.

According to some further aspects of the present disclosure, a lighting device comprises a housing, a battery disposed within the housing, a light emitting element supported by the housing, a switch for opening and closing an electrical current path between the battery and the light emitting element, and a magnet supported by the housing for magnetically securing the lighting device to a ferrous metal object. The magnet can be moveable relative to the housing such that movement of the magnet to a first position causes the switch to open the electrical current path and movement of the magnet to a second position causes the switch to close the electrical current path.

In some embodiments, the lighting device further comprises a battery housing that at least partially surrounds the battery within the housing. In some embodiments, the lighting device further comprises a resistor disposed within the housing and electrically connected between the battery and the light emitting element. In some embodiments, the light emitting element comprises a light emitting diode.

In some embodiments, the lighting device further comprises a carriage attached to the magnet between the magnet and the battery. In some such embodiments, the switch includes a sliding element that moves between an open-switch position that blocks electrical current from flowing between the light emitting element and the battery, and a closed-switch position that allows electrical current to flow between the light emitting element and the battery. In some such embodiments, the carriage can be attached to the sliding element of the switch such that movement of the magnet can cause the sliding element to move between the open-switch position and the closed-switch position.

According to still further aspects of the present disclosure, a lighting device comprises a housing, a battery disposed within the housing, a light emitting element extending from a first end of the housing, a switch extending from a second end of the housing opposite the first end of the housing, the switch being operable by a user for opening and closing an electrical current path between the battery and the light emitting element, and a magnet supported by the housing and extending between the first and second ends of the housing, the magnet being suitable for magnetically securing the lighting device to a ferrous metal object. At least one of the housing and the magnet includes a recess that extends between the first and second ends of the housing.

In some embodiments, the lighting device further comprises a resistor disposed within the housing and electrically connected between the battery and the light emitting element. In some embodiments, the lighting device further comprises a battery housing that at least partially surrounds the battery within the housing. In some embodiments, the light emitting element comprises a light emitting diode.

### BRIEF DESCRIPTION OF THE DRAWINGS

Features, aspects, and embodiments of the present disclosure are described in conjunction with the attached drawings, in which:

FIG. 1 shows a front perspective view of a first embodiment of a pod light of the present disclosure attached to a hand tool;

FIG. 2 shows a perspective view of the pod light shown in FIG. 1;

FIG. 3 shows a top view of the pod light shown in FIG. 1;

FIG. 4 shows a side view of the pod light shown in FIG. 1;

FIG. 5 shows a back view of the pod light shown in FIG. 1;

FIG. 6 shows a bottom view of the pod light shown in FIG. 1;

FIGS. 7A-7D show partial sectional views of respective embodiments taken along section line VII-VII shown in FIG. 6;

FIG. 8 shows a schematic electrical diagram of a pod light according to the present disclosure;

FIG. 9 shows a cross-sectional view, taken along section line IX-IX shown in FIG. 3, of an embodiment of a pod light according to the present disclosure;

FIGS. 10A and 10B show a cross-sectional view, taken along section line IX-IX shown in FIG. 3, of an alternative embodiment of a pod light according to the present disclosure;

FIG. 11 shows a sectional views of the pod light shown in FIGS. 10A and 10B taken along section line XI-XI in FIG. 10A;

FIGS. 12A and 12B show plan views of embodiments of a pod light according to the present disclosure where the pod light is attached to a hand tool and in respective positions for turning the LED on and off;

FIGS. 13A and 13B show a cross-sectional view, taken along section line IX-IX shown in FIG. 3, of an alternative embodiment of a pod light according to the present disclosure;

FIG. 14 shows a sectional views of the pod light shown in FIGS. 13A and 13B, and of the pod light shown in FIGS. 15A and 15B, taken along section line XIV-XIV in FIGS. 13A and 15A;

FIGS. 15A and 15B show a cross-sectional view, taken along section line IX-IX shown in FIG. 3, of an alternative embodiment of a pod light according to the present disclosure;

FIGS. 16A and 16B show a cross-sectional view, taken along section line IX-IX shown in FIG. 3, of an alternative embodiment of a pod light according to the present disclosure;

FIG. 17 shows a sectional view of the pod light shown in FIGS. 16A and 16B taken along section line XVII-XVII in FIGS. 16A and 16B; and

FIGS. 18A and 18B show a cross-sectional view, taken along section line XVIII-XVIII shown in FIG. 4, of an alternative embodiment of a pod light according to the present disclosure.

### DETAILED DESCRIPTION

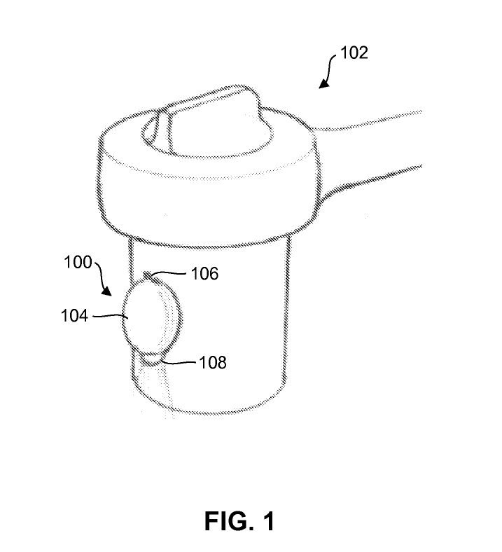

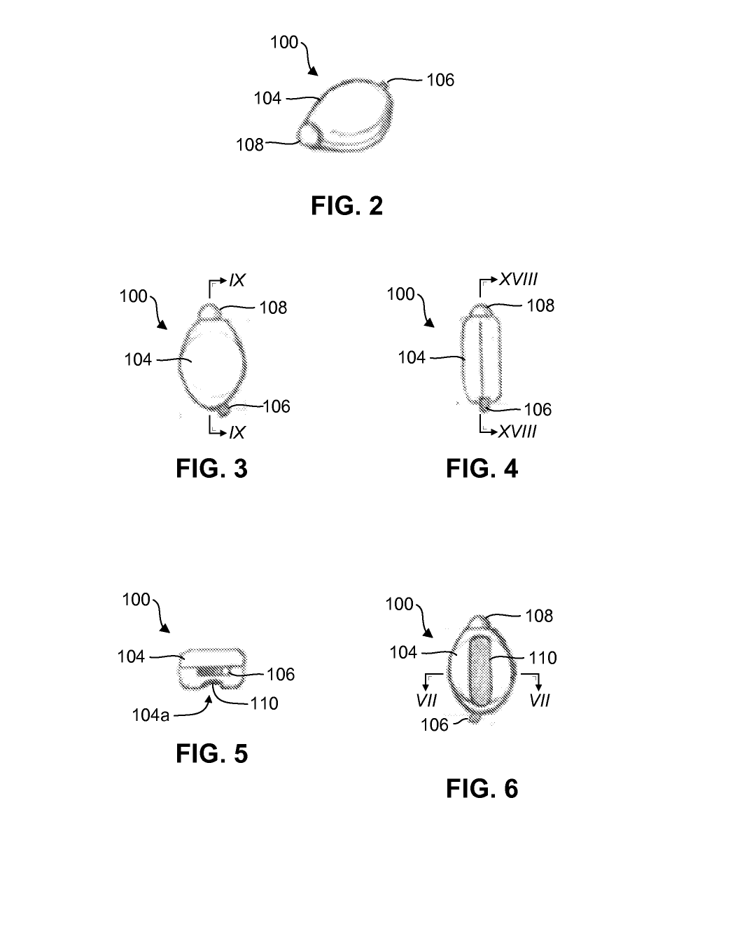

FIGS. 1-6 show an embodiment of a compact lighting device 100, also referred to herein as pod light 100. In FIG. 1, the pod light 100 is shown attached to a hand tool 102, or more specifically a socket of a socket wrench 102, although the pod light 100 can be attached to a great variety of different hand tools or other items.

The pod light 100 includes a housing 104, a switch 106, a light emitting diode (LED) 108, and a magnet 110.

The housing 104 can be rigid or malleable. The housing 104 can be made of any of a variety of different materials, such as plastic or polymer materials. For example, in some embodiments, the housing 104 can include thermoplastic elastomer (TPE) or thermoplastic rubber (TPR) material. The housing 104 can include metal material, but the metal should preferably be insulated from internal circuitry of the pod light 100.

The switch 106 can be any type of switch that can be operated by a user to turn the LED on and off. For example, the switch 106 can be a toggle switch, a pushbutton switch, or a slide switch. The switch 106 is mounted within the housing 104, although preferable an operable portion of the switch is exposed for user operation.

The LED 108 is supported by the housing 104 and is in operable communication with the switch such that the LED 108 can be turned on and off by the use of the switch 106. The LED 108 is preferably configured to emit a white color of light, although other light colors can be used, including colors that are outside of the visible spectrum, such as infrared LEDs. In some embodiments, the LED 108 includes a single anode and a single cathode across which a voltage can be applied for causing the LED 108 to emit light. Alternative embodiments can include a common anode/multiple cathode LED or a common cathode/multiple anode LED as the LED 108. Such embodiments can allow for multi-colored lighting from the LED 108 and/or multiple brightness levels of light emitted from the LED 108. While the embodiments are described as including an LED 108, other types light emitting elements can be used.

The magnet 110 is supported by the housing 104 and is exposed to an exterior of the housing 104. The magnet 110 can be used to attach the pod light 100 to a ferrous metal object. Thus, the strength of the magnet 110 should be chosen such that the magnet 110 can keep the pod light 100 attached to a ferrous metal object, such as the hand tool 102, without requiring extraordinary force to be removed from the ferrous metal object.

As shown in FIG. 5, the housing 104 can include a groove 104a formed in the bottom of housing 104. The magnet 110 can be exposed toward the groove 104a, thereby causing the magnet 110 to be at least somewhat recessed relative to the bottom extent of the housing 104. This configuration allows the pod light 100 to at least somewhat conform to, and automatically align with, the side of a cylindrical surface, such as the side of the socket shown in FIG. 1, thereby reducing the possibility of rotational movement of the pod light 100 about an axis normal to the bottom plane of the pod light 100 while the pod light 100 is attached to the side of a cylindrical object. Alternatively, the magnet 110 can be flush against the bottom of the housing 104 and the magnet can have a groove formed therein.

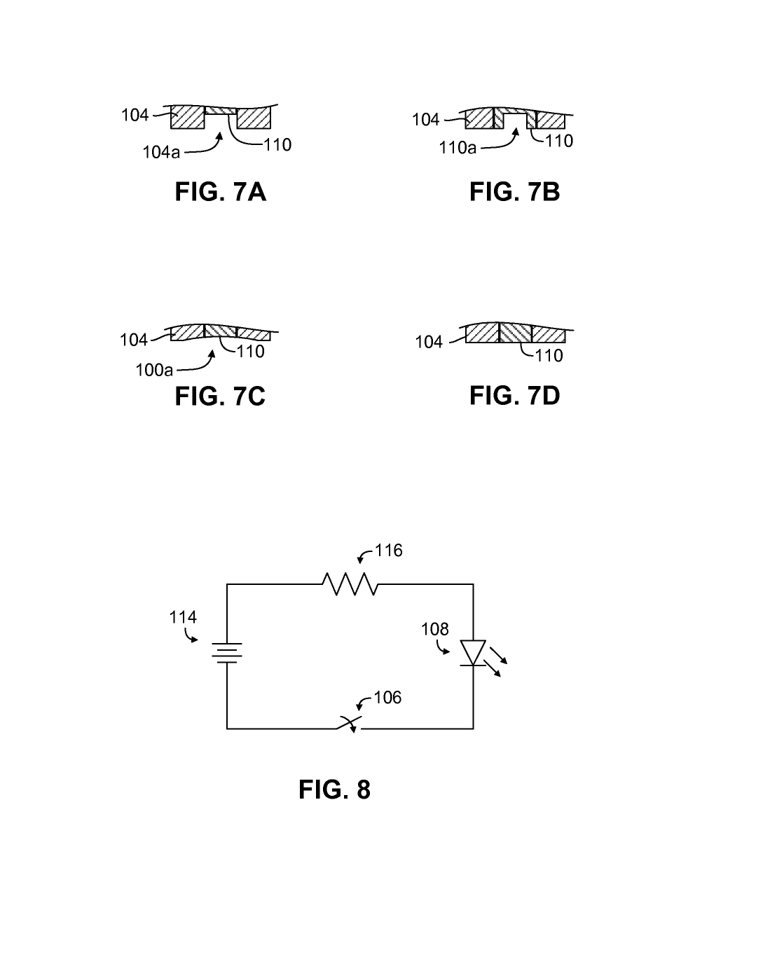

FIGS. 7A-7D show partial sectional views of respective embodiments taken along section line VII-VII shown in FIG. 6, where each of FIGS. 7A-7D corresponds to a different embodiment of the pod light 100. FIGS. 7A-7D show examples of how the bottom side of the housing 104 and the magnet 110 can be configured.

In the embodiment shown in FIG. 7A, the housing 104 has a groove 104a formed therein. The groove 104a can extend the length of the housing 104, e.g., from the LED 108 to the switch 106. The magnet 110 is recessed in the groove 104a. The view shown in FIG. 7A corresponds to the embodiment shown in FIG. 5.

In the embodiment shown in FIG. 7B, the magnet 110 is flush with the bottom of the housing 104, and the magnet 110 has a groove 110a formed therein. The groove 110a can extend the length of the housing 104, e.g., from the LED 108 to the switch 106.

In the embodiment shown in FIG. 7C, the magnet 110 is flush with the bottom of the housing 104, and a groove 100a is formed from both the magnet 110 and housing 104 in the light pod 100. The groove 100a can extend the length of the housing 104, e.g., from the LED 108 to the switch 106.

In the embodiment shown in FIG. 7D, the magnet 110 is flush with the bottom of the housing 104 so that the bottom of the pod light 100 is substantially flat.

FIG. 8 shows a schematic electrical diagram of the pod light 100. As discussed above, the pod light 100 can include a switch 106 and an LED 108. The pod light 100 can also include a battery 114 and a resistor 116. The battery 114 can include one or more battery elements, such as one or more button cell batteries (single cell batteries shaped as a squat cylinders), and the resistor 116 can include one or more resistive elements. The battery 114 and resistor 116 can be selected according to the specifications of the LED 108 so that the proper electrical voltage and current are provided to illuminate the LED 108 while the switch 106 is closed. In some embodiments, the resistor 116 can be omitted, for example where the battery 114 can directly drive the LED 108. The resistor 116 is sometimes desirable for helping to control the amount of electrical current that is drawn from the battery 116. Thus, the resistor 116 can be desirable for extending the life of the battery 114 and controlling the brightness of the LED 108. However, such current control can be accomplished with other circuitry or can be omitted altogether in alternative embodiments.

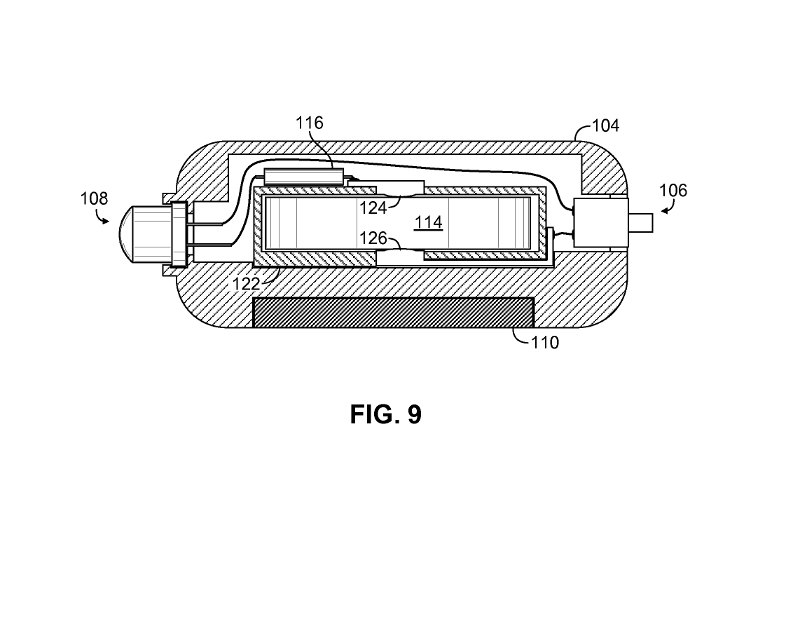

FIG. 9 shows a cross-sectional view, taken along section line IX-IX shown in FIG. 3, of an embodiment of the pod light 100. As described above, the pod light 100 includes a housing 104, a switch 106, an LED 108, a magnet 110, a battery 114, and a resistor 116. The battery 114 is centrally located within a battery housing 122.

The battery housing 122 is preferably formed of an electrically insulating material, such as plastic or rubber material. The battery housing 122 includes a first electrical contact 124 for making electrical contact with the positive terminal of the battery 114, and a second electrical contact 126 for making electrical contact with the negative terminal of the battery 114.

The electrical contacts 124 and 126 can be made of any electrically conductive material, such as copper, silver, or gold. The electrical contacts 124 and 126 can include conductive battery contacts, conductive wires, conductive traces on a printed circuit board, and/or any other form of conductive material.

The housing 104 can be formed of two or more pieces, for example by known molding processes, and the two or more pieces can be assembled using any desired combination of known assembly techniques, such as snaps, slides, hinges, connection hardware, adhesives, or other connection techniques. The housing 104 can be permanently assembled so that the pod light 100 is disposable, e.g., once the battery 114 is discharged. Alternatively, the housing 104 (and battery housing 122) can include battery-access means, such as an opening or an access door, for allowing a user access for replacing the battery 114.

The positive terminal of the battery 114 is electrically connected to the anode of the LED 108 via the first electrical contact 124 and the resistor 116. The negative terminal of the battery 114 is electrically connected to the cathode of the LED 108 via the second electrical contact 126 and the switch 106. Thus, as shown in FIG. 8, the switch 106 can be used to control activation of the LED 108. In some embodiments the resistor 116 can be omitted and the positive terminal of the battery 114 can be electrically connected to the anode of the LED 108 via the first electrical contact 124.

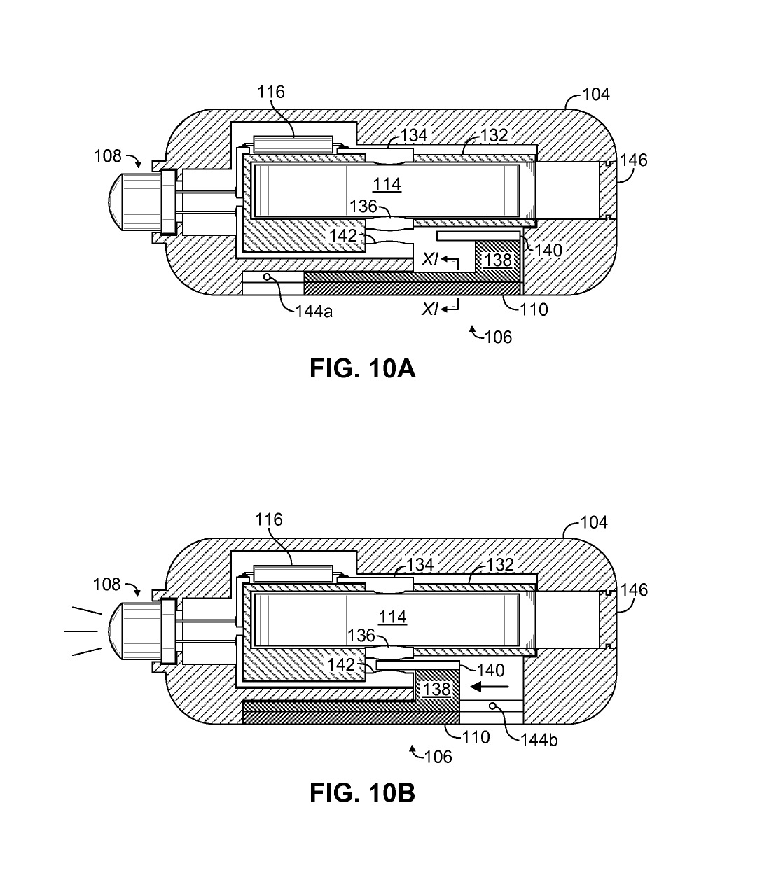

FIGS. 10A and 10B show a cross-sectional view, taken along section line IX-IX shown in FIG. 3, of an alternative embodiment of the pod light 100. In FIGS. 10A and 10B, an embodiment is shown where the switch 106 includes a sliding embodiment of the magnet 110.

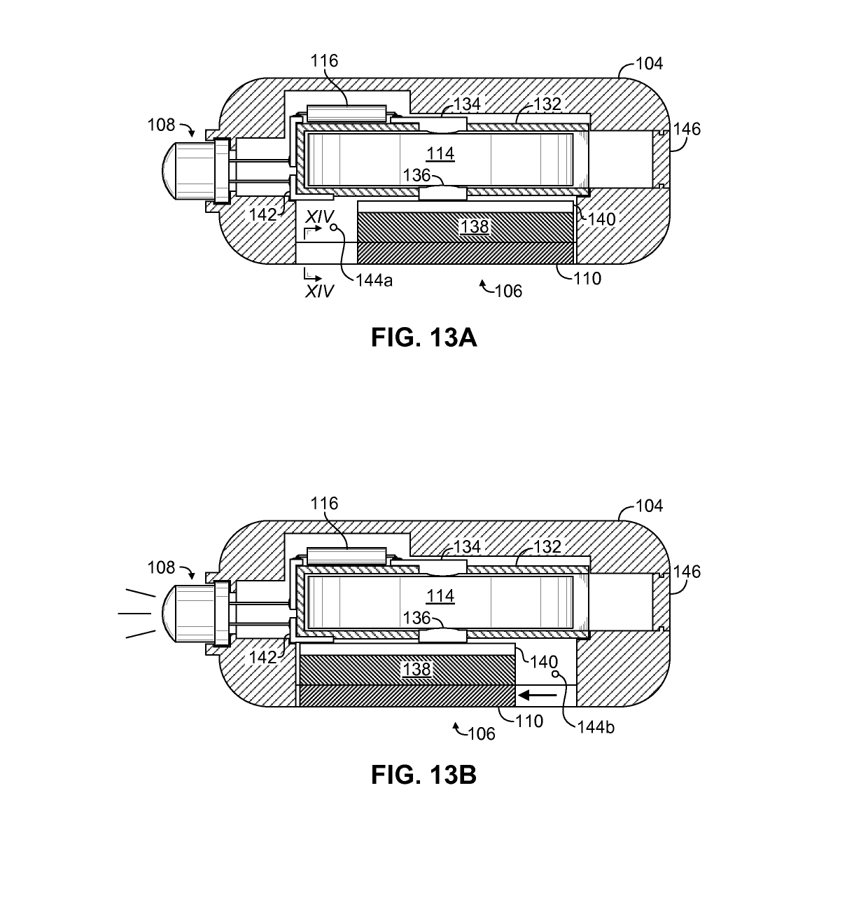

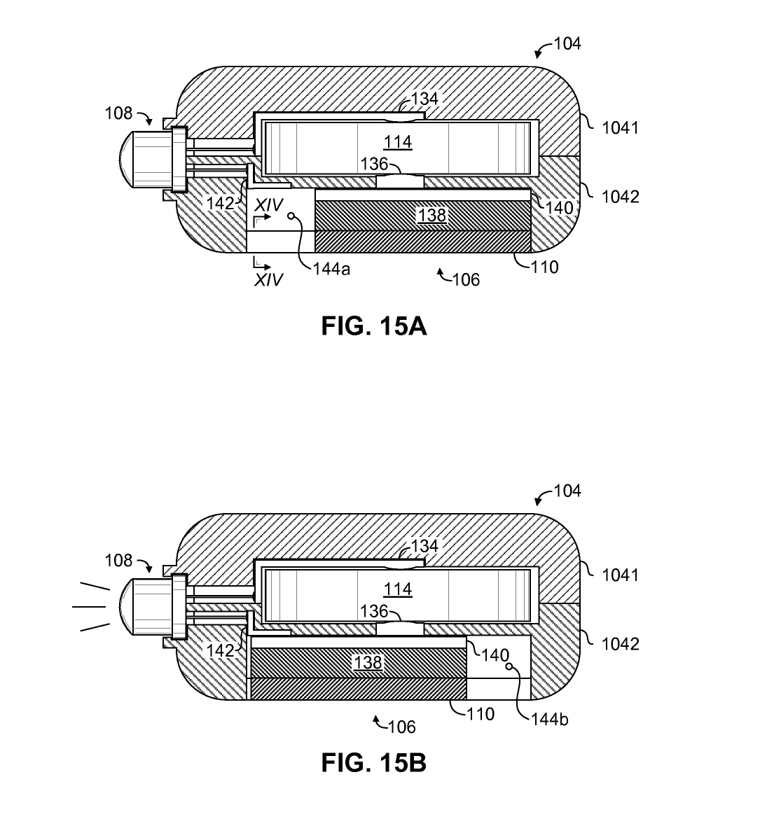

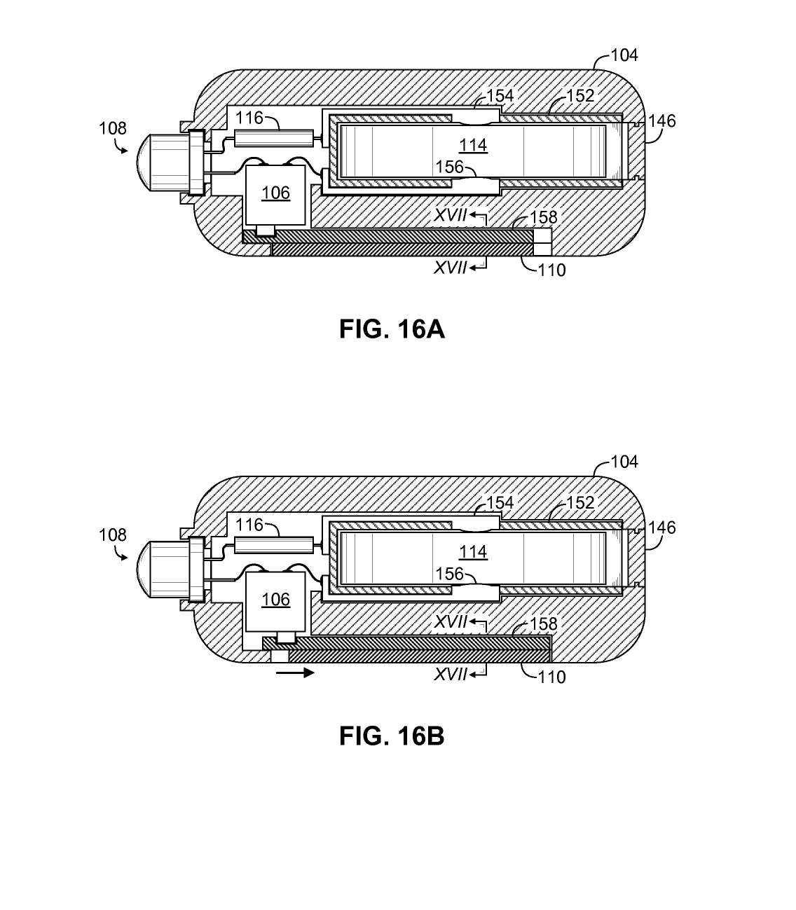

Before describing the embodiment of the pod light 100 shown in FIGS. 10A and 10B, operation of the pod light 100 with the sliding magnet switch 106 will be described with reference to FIGS. 12A and 12B. The pod light 100 with the sliding magnet switch 106 can be attached to a hand tool 102 as shown in FIG. 12A, where the magnet 110 is holding the pod light 100 to the hand tool 102, and the LED 108 is off. Then, a user can slide the housing 104 rearward while the magnet 110 stays fixed to the hand tool 102 so that the housing 104 moves relative to the magnet 110, thereby activating (turning on) the LED 108 as shown in FIG. 12B. The LED 108 can then be turned back off by sliding the housing 104 in the opposite direction relative to the magnet 110 and hand tool 102. The amount of movement necessary to activate the LED 108 can vary depending on how the pod light 100 and sliding magnet switch 106 are constructed. In alternative embodiments, the direction of movement can be reversed (for example, by rearranging the components in FIGS. 10A and 10B, or by rearranging the components in FIGS. 13A and 13B, or by rearranging the components in FIGS. 15A and 15B, or by reversing the switch 106 in FIGS. 16A and 16B) so that sliding the housing 104 forward relative to the magnet 110 turns on the LED 108, and sliding the housing rearward relative to the magnet 110 turns off the LED 108. In still further embodiments, the housing 104 can be moved in some other direction, such as laterally, vertically, or rotationally, relative to the hand tool 102 and magnet 110 to turn the LED 108 on and off.

Referring again to FIGS. 10A and 10B, the view shown in FIG. 10A corresponds to the view shown in FIG. 12A with the LED 108 turned off, and the view shown in FIG. 10B corresponds to the view shown in FIG. 12B with the LED 108 turned on.

As described above, the pod light 100 includes a housing 104, a switch 106, an LED 108, a magnet 110, a battery 114, and a resistor 116.

The battery 114 is somewhat centrally located within a battery housing 132. The battery housing 132 is preferably formed of an electrically insulating material, such as plastic or rubber material. The battery housing 132 can be an integrated portion of the housing 104 or a separate component or group of components. The battery housing 132 includes a first electrical contact 134 for making electrical contact with the positive terminal of the battery 114, and a second electrical contact 136 for making electrical contact with the negative terminal of the battery 114.

The electrical contacts 134 and 136, as well as the electrical conductors 140 and 142 described below, can be made of any electrically conductive material, such as copper, silver, or gold. The electrical contacts 134 and 136, as well as the electrical conductors 140 and 142, can include conductive battery contacts, conductive wires, conductive traces on a printed circuit board, and/or any other form of conductive material.

The housing 104 can be formed of two or more pieces, for example by known molding processes, and the two or more pieces can be assembled using any desired combination of known assembly techniques, such as snaps, slides, hinges, connection hardware, adhesives, or other connection techniques. The housing 104 can be permanently assembled so that the pod light 100 is disposable, e.g., once the battery 114 is discharged. Alternatively, the housing 104 (and battery housing 132) can include battery-access means, such as an opening or an access door 146, for allowing a user access for replacing the battery 114.

The positive terminal of the battery 114 is electrically connected to the anode of the LED 108 via the first electrical contact 134 and the resistor 116. The negative terminal of the battery 114 is electrically connected to the cathode of the LED 108 via the second electrical contact 136 and the switch 106. More specifically, when the switch 106 is closed as shown in FIG. 10B, the negative terminal of the battery 114 is electrically connected to the cathode of the LED 108 via the second electrical contact 136 and via electrical conductors 140 and 142. When the switch 106 is open as shown in FIG. 10A, an air gap is present between the second electrical contact 136 and electrical conductor 142 so that no electrical current can flow through the LED 108.

The electrical conductor 140 is carried by the magnet 110. More specifically, a carriage 138 is attached to the top of the magnet 110, and the electrical conductor 140 is attached to the carriage 138. The carriage 138 is preferably constructed of an electrically insulating material, such as rubber or plastic. The electrical conductor 140, carriage 138, and magnet 110 are fixed together, and therefore can slide together relative to the housing 104 in both a forward direction (toward the LED 108) and a rearward direction (away from the LED 108). In some embodiments, the carriage 138 can be omitted and the conductor 140 can be fixed directly to the top of the magnet 110.

The housing 104 can be provided with one or more protrusions, snaps, detents, or other retaining means, such as detents 144a and 144b, to prevent the conductor 140, carriage 138, and magnet 110 from freely sliding relative to the housing 104. Alternatively, the conductor 140, carriage 138, and magnet 110 can fit snugly in the housing 104 so as to be frictionally held in place rather than freely sliding. In general, the amount of force required to slide the magnet 110 relative to the housing 104 should be less than the amount of force required to slide the magnet 110 relative to a ferrous metal object, such as a hand tool 102, so that a user can operate the switch 106 as shown in FIGS. 12A and 12B without the magnet 110 sliding across the hand tool 102.

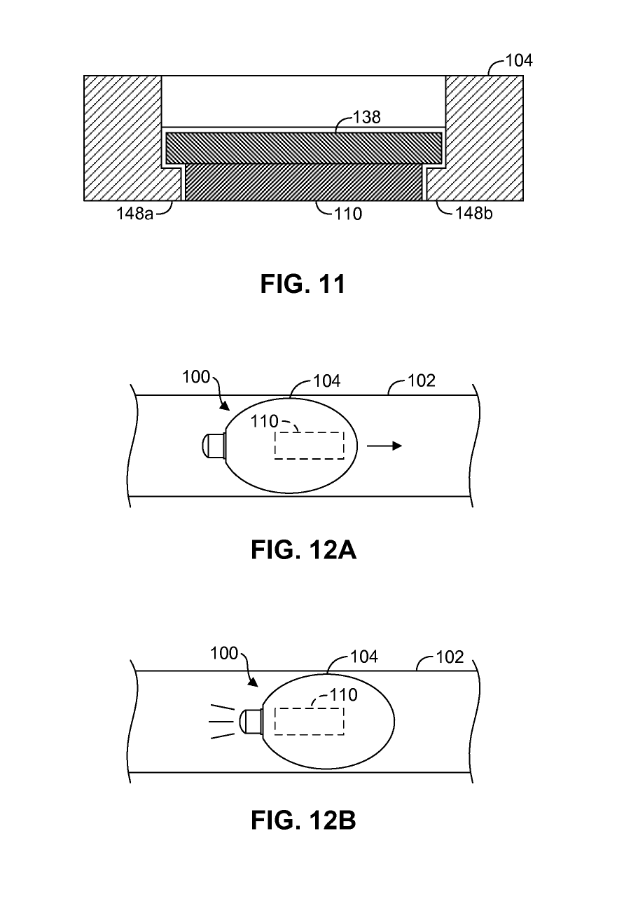

FIG. 11 shows a cross-sectional view taken along section line XI-XI in FIG. 10A. As shown in FIG. 11, the housing 104 can be shaped so as to include shoulders 148a and 148b.

The carriage 138 can be wider than the magnet 110 so that the carriage 138 overhangs the edges of the magnet 110 and extends over shoulders 148a and 148b. This configuration allows the housing 104 to retain the conductor 140, carriage 138, and magnet 110. In embodiments where the carriage 138 is omitted and the conductor 140 is attached to the top of the magnet 110, one or both of the magnet 110 and the conductor 140 can be formed so as to be retained by the shoulders 148a and 148b.

Thus, the sliding magnet switch 106 can be used to control activation of the LED 108. In some embodiments the resistor 116 can be omitted and the positive terminal of the battery 114 can be electrically connected to the anode of the LED 108 via the first electrical contact 134.

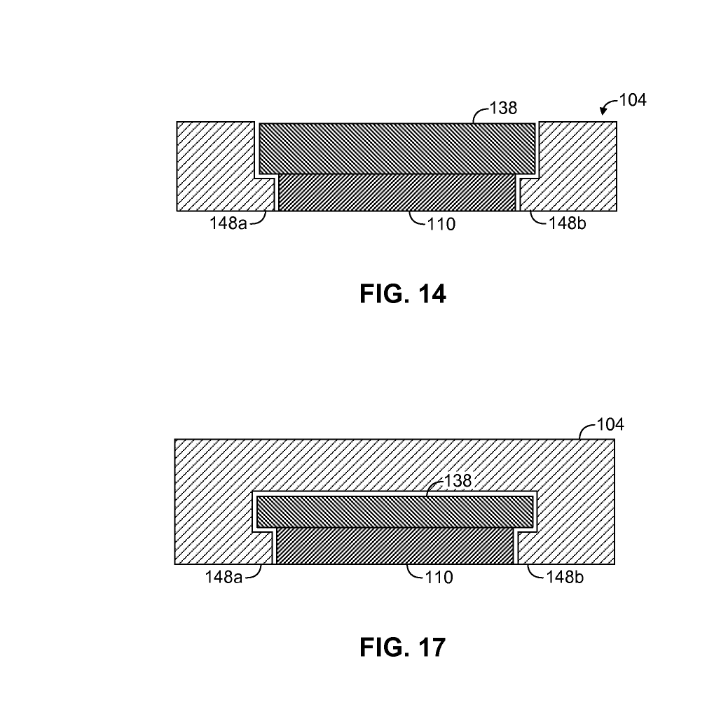

FIGS. 13A and 13B show a cross-sectional view, taken along section line IX-IX shown in FIG. 3, of an alternative embodiment of the pod light 100. The embodiment shown in FIGS. 13A and 13B is substantially the same as the embodiment shown in FIGS. 10A and 10B, except as described below with reference to FIGS. 13A, 13B, and 14.

In FIGS. 13A and 13B, the electrical conductor 142 is beside the electrical contact 136 rather than below it. Also, in the embodiment shown in FIGS. 13A and 13B, the carriage 138 and contact 140 extend further across the top of the magnet 110. As a result, the sectional view shown in FIG. 14, taken along section lines XIV-XIV in FIG. 13A differs slightly from the corresponding sectional view shown in FIG. 11 of the embodiment shown in FIGS. 10A and 10B.

In FIG. 13A, the conductor 142 is spaced from the contact 136, resulting in an open electrical circuit so that the LED 108 is off. In FIG. 13B, the magnet 110, carriage 138, and contact 140 have been moved closer to the LED 108 relative to the housing 104. As a result, the contact 140 provides an electrical connection between conductor 142 and contact 136 so that the circuit is closed and the LED 108 is turned on. Thus, the embodiment of the pod light 100 shown in FIGS. 13A and 13B can operate as shown in FIGS. 12A and 12B and described above.

FIGS. 15A and 15B show a cross-sectional view, taken along section line IX-IX shown in FIG. 3, of an alternative embodiment of the pod light 100. The embodiment shown in FIGS. 15A and 15B is similar to the embodiment shown in FIGS. 13A and 13B, except as described below with reference to FIGS. 15A and 15B.

In FIGS. 15A and 15B, the resistor 116 and the battery housing 132 have been omitted. The battery 114 has sides that are electrically isolated from the negative terminal of the battery 114, so the first electrical contact 134 can be adjacent to the side of the battery 114 without being insulated from the battery 114 by the battery housing 132.

Also, FIGS. 15A and 15B show an example of how the housing 104 can be divided into multiple housing members. In FIGS. 15A and 15B, the housing 104 includes an upper housing member 1041 and a lower housing member 1042. As described above, the upper and lower housing members 1041 and 1042 can be assembled using any desired combination of known assembly techniques, such as snaps, slides, hinges, connection hardware, adhesives, or other connection techniques. In some embodiments, the upper and lower housing members 1041 and 1042 can be permanently attached to each other so that the pod light 100 is disposable, e.g., once the battery 114 is discharged. Alternatively, the upper and lower housing members 1041 and 1042 can be assembled so that a user can detach and re-attach them to each other in order to replace the battery 114.

In some alternative embodiments, the resistor 116 can be included in the embodiment shown in FIGS. 15A and 15B while the battery housing 132 remains omitted, for example connecting the resistor 116 between the anode of the LED 108 and the first electrical contact 134 as shown in FIGS. 13A and 13B. Also, in some alternative embodiments, the battery housing 132 can be included in the embodiment shown in FIGS. 15A and 15B while the resistor 116 remains omitted.

FIGS. 16A and 16B show a cross-sectional view, taken along section line IX-IX shown in FIG. 3, of another alternative embodiment of the pod light 100. In FIGS. 16A and 16B, an embodiment is shown where a slide switch 106 is operated by a sliding embodiment of the magnet 110.

The description of the operation of the pod light 100 with the sliding magnet switch 106 described above with reference to FIGS. 12A and 12B applies equally to the embodiment shown in FIGS. 16A and 16B. The view shown in FIG. 16A corresponds to the view shown in FIG. 12A, and the view shown in FIG. 16B corresponds to the view shown in FIG. 12B.

However, as mentioned above, the on and off positions can be reversed depending on how the switch 106 is installed. So in some embodiments, the LED 108 can be off in FIG. 16A and the LED 108 can be on in FIG. 16B, while in other embodiments, the switch 106 can be reversed so that the LED 108 is on in FIG. 16A and the LED 108 is off in FIG. 16B.

As described above, the pod light 100 includes a housing 104, a switch 106, an LED 108, a magnet 110, a battery 114, and a resistor 116.

The battery 114 is somewhat centrally located within a battery housing 152. The battery housing 152 is preferably formed of an electrically insulating material, such as plastic or rubber material. The battery housing 152 can be an integrated portion of the housing 104 or a separate component or group of components. The battery housing 152 includes a first electrical contact 154 for making electrical contact with the positive terminal of the battery 114, and a second electrical contact 156 for making electrical contact with the negative terminal of the battery 114.

The electrical contacts 154 and 156 can be made of any electrically conductive material, such as copper, silver, or gold. The electrical contacts 154 and 156 can include conductive battery contacts, conductive wires, conductive traces on a printed circuit board, and/or any other form of conductive material.

The housing 104 can be formed of two or more pieces, for example by known molding processes, and the two or more pieces can be assembled using any desired combination of known assembly techniques, such as snaps, slides, hinges, connection hardware, adhesives, or other connection techniques. The housing 104 can be permanently assembled so that the pod light 100 is disposable, e.g., once the battery 114 is discharged. Alternatively, the housing 104 (and battery housing 152) can include battery-access means, such as an opening or an access door 146, for allowing a user access for replacing the battery 114.

The positive terminal of the battery 114 is electrically connected to the anode of the LED 108 via the first electrical contact 154 and the resistor 116. The negative terminal of the battery 114 is electrically connected to the cathode of the LED 108 via the second electrical contact 156 and the switch 106. More specifically, when the switch 106 is closed, the negative terminal of the battery 114 is electrically connected to the cathode of the LED 108. When the switch 106 is open, the switch 106 insulates the negative terminal of the battery 114 from the cathode of the LED 108 so that no electrical current can flow through the LED 108.

The switch 106 is a slide switch operated by the magnet 110. More specifically, a carriage 158 is attached to the top of the magnet 110, and the sliding portion of the slide switch 106 is attached to the carriage 158. The carriage 158 is preferably constructed of an electrically insulating material, such as rubber or plastic. The carriage 158 and magnet 110 are fixed together, and therefore can slide together relative to the housing 104 in both a forward direction (toward the LED 108) and a rearward direction (away from the LED 108). In some embodiments, the carriage 158 can be omitted and the sliding portion of the slide switch 106 can be attached directly to the magnet 110.

FIG. 17 shows a cross-sectional view taken along section line XVII-XVII in FIGS. 16A and 16B. As shown in FIG. 17, the housing 104 can be shaped so as to include shoulders 148a and 148b. The carriage 158 can be wider than the magnet 110 so that the carriage 158 overhangs the edges of the magnet 110 and extends over shoulders 148a and 148b. This configuration allows the housing 104 to retain the carriage 158 and magnet 110. In embodiments where the carriage 158 is omitted, the magnet 110 can be formed so as to be retained by the shoulders 148a and 148b.

Thus, the sliding magnet 110 can be used to control the switch 106, and thereby control activation of the LED 108. In some embodiments the resistor 116 can be omitted, and the positive terminal of the battery 114 can be electrically connected to the anode of the LED 108 via the first electrical contact 154.

As pointed out above, in still further embodiments, the magnet switching assembly 106 can be arranged so that the housing 104 can be moved in some direction other than forward and rearward relative to the magnet 110 to turn the LED 108 on and off, such as laterally, vertically, or rotationally relative to the magnet 110. For example, in the embodiment shown in FIGS. 16A and 16B, the switch 106 can be rotated 90 degrees about its vertical axis so that the magnet 110 can be moved laterally (in and out of the page as shown in FIGS. 16A and 16B) relative to the housing 104 to operate the switch 106 and turn the LED 108 on and off. A rotational embodiment can be realized by replacing slide switch 106 in FIGS. 16A and 16B with a rotary switch 106 so that the magnet 110 can be rotated relative to the housing 104 to operate the rotary switch 106 and turn the LED 108 on and off. A push-to-activate embodiment can be realized by replacing slide switch 106 in FIGS. 16A and 16B with a pushbutton switch 106 so that the magnet 110 can be moved vertically relative to the housing 104 to operate the pushbutton switch 106 and turn the LED 108 on and off. Such pushbutton embodiments can include those with a momentary pushbutton switch, for example where the LED 108 remains on only while the user is pushing on the housing 104 causing the magnet 110 to press the button of the pushbutton switch 106. Such pushbutton embodiments can also include those with a push-on/push-off pushbutton switch, for example where the LED 108 is turned on by one push of the housing 104 causing the magnet 110 to press the button of the pushbutton switch 106, and turned off by another push of the housing 104 causing the magnet 110 to again press the button of the pushbutton switch 106.

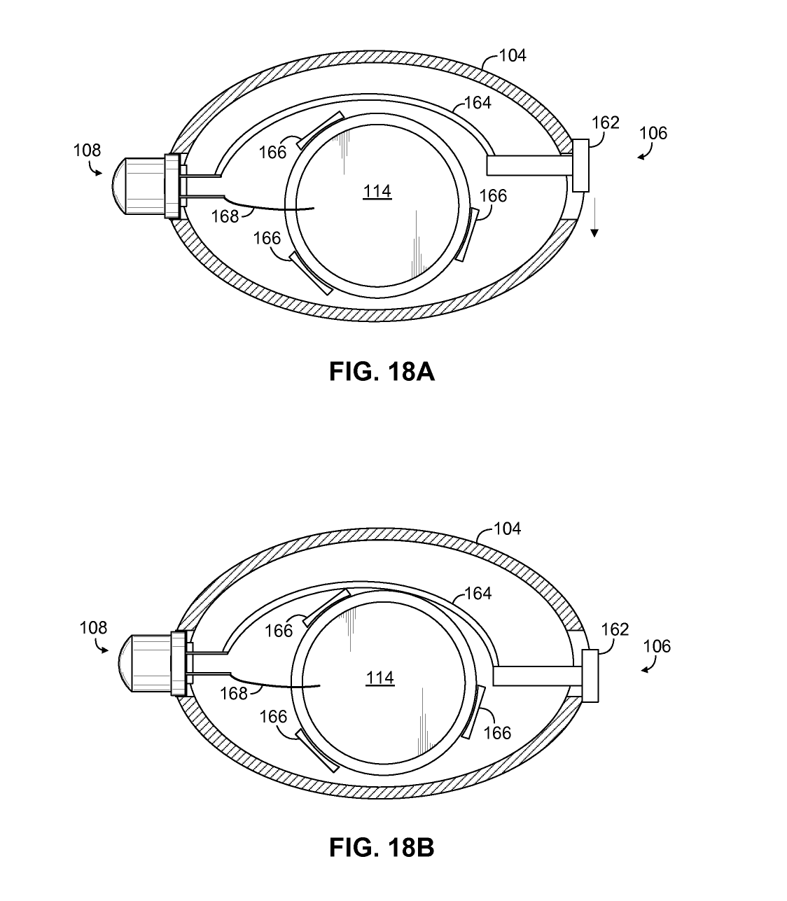

FIGS. 18A and 18B show a cross-sectional view, taken along section line XVIII-XVIII shown in FIG. 4, of another alternative embodiment of the pod light 100. In FIGS. 18A and 18B, an embodiment is shown where a slide switch 106 is positioned opposite the LED 108 (e.g., as shown in FIGS. 1-6 and 9) rather than being on a bottom side adjacent the magnet 110.

The description of the operation of the embodiment of the pod light 100 shown in FIG. 9 applies equally to the embodiment shown in FIGS. 18A and 18B, except that the embodiment shown in FIGS. 18A and 18B includes a switch 106 that comprises a switching member 162 and lever member 164, in place of the discrete switch 106 shown in FIG. 9. The view shown in FIG. 18A corresponds with the off state of the pod light 100, and the view shown in FIG. 18B corresponds with the on state of the pod light 100.

As described above, the pod light 100 includes a housing 104, a switch 106, an LED 108, a magnet 110, and a battery 114. The embodiment of the pod light 100 shown in FIGS. 18A and 18B can also include a resistor 116.

The battery 114 is located within the housing 104 and is held in place by one or more battery holders 166. A first electrical contact 168 is provided for making electrical contact with the negative terminal of the battery 114, and the lever member 164 is provided for making electrical contact with the positive terminal of the battery 114.

The lever member 164 and the electrical contact 168 can be made of any electrically conductive material, such as copper, silver, or gold. The electrical contact 168 can include conductive battery contacts, conductive wires, conductive traces on a printed circuit board, and/or any other form of conductive material. The lever member 164 can be made of a flexible electrically-conductive material, such as a flexible metallic material, that can move between the position shown in FIG. 18A and the position shown in FIG. 18B.

The housing 104 can be formed of two or more pieces, for example by known molding processes, and the two or more pieces can be assembled using any desired combination of known assembly techniques, such as snaps, slides, hinges, connection hardware, adhesives, or other connection techniques. The housing 104 can be permanently assembled so that the pod light 100 is disposable, e.g., once the battery 114 is discharged. Alternatively, the housing 104 can include battery-access means, such as an opening or an access door, for allowing a user access for replacing the battery 114.

The negative terminal of the battery 114 is electrically connected to the cathode of the LED 108 via the electrical contact 168. The positive terminal of the battery 114 is electrically connected to the anode of the LED 108 via the lever member 164 when the switching member 162 is in the position shown in FIG. 18B; the positive terminal of the battery 114 is electrically disconnected from the anode of the LED 108 when the switching member 162 and lever member 164 are in the position shown in FIG. 18A. Thus, in FIG. 18A the switch 106 is closed, so the positive terminal of the battery 114 is electrically connected to the anode of the LED 108, thereby completing the electrical circuit between the battery 114 and the LED 108 and causing the LED 108 to emit light. When the switch 106 is open, the lever member 164 is moved away from the positive terminal of the battery 114 so that an air gap is formed between the lever member 164 and the positive terminal of the battery 114, thereby opening the electrical circuit between the battery 114 and the LED 108 and causing the LED 108 to be disabled (not emit light).

The switch 106 is a slide switch that a user can operate by use of the switching member 162. More specifically, a user can slide the switching member 162 between the positions shown in FIGS. 18A and 18B. The switching member 162 is attached to the lever member 164 so that the lever member 164 moves as the switching member 162 moves. Thus, when a user wishes to turn on the pod light 100, the user can move, or slide, the switching member 162 from the off-position shown in FIG. 18A to the on-position shown in FIG. 18B. The repositioning of the switching member 162 causes the lever member 164 to also move from the off-position shown in FIG. 18A to the on-position shown in FIG. 18B since the lever member 164 is attached to the switching member 162. Conversely, when a user wishes to turn off the pod light 100, the user can move, or slide, the switching member 162 from the on-position shown in FIG. 18B to the off-position shown in FIG. 18A. The repositioning of the switching member 162 causes the lever member 164 to also move from the on-position shown in FIG. 18B to the off-position shown in FIG. 18A since the lever member 164 is attached to the switching member 162.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

1. A lighting device, comprising:
a housing;
a battery disposed within the housing;
a light emitting element supported by the housing; and
a switch operable by a user for opening and closing an electrical current path between the battery and the light emitting element,
wherein the switch comprises a magnet supported by the housing,
wherein the magnet is longitudinally moveable between a first position where the electrical current path is open and a second position where the electrical current path is closed.

2. The lighting device of claim 1, further comprising a battery housing that at least partially surrounds the battery within the housing.

3. The lighting device of claim 1, wherein the switch further comprises a carriage attached to the magnet between the magnet and the battery and an electrical conductor attached to the carriage between the carriage and the battery.

4. The lighting device of claim 3, wherein the electrical conductor provides a portion of the electrical current path between the battery and the light emitting element when the magnet is in the second position.

5. The lighting device of claim 1, wherein the switch further comprises an electrical conductor attached to the magnet between the magnet and the battery.

6. The lighting device of claim 5, wherein the electrical conductor provides a portion of the electrical current path between the battery and the light emitting element when the magnet is in the second position.

7. The lighting device of claim 1, further comprising a first electrical conductor that is electrically connected to the light emitting element, and the switch further comprising a second electrical conductor that is fixed to the magnet, wherein the first electrical conductor extends between the second electrical conductor and the magnet when the magnet is in the second position.

8. The lighting device of claim 1, further comprising a first electrical conductor that is electrically connected to the light emitting element and an electrical contact that is electrically connected to the battery, the first electrical conductor having a lower surface that is substantially coplanar with a lower surface of the electrical contact.

9. The lighting device of claim 8, wherein the switch further comprises a second electrical conductor that is fixed to the magnet, wherein the second electrical conductor provides a portion of the electrical current path between the battery and the light emitting element when the magnet is in the second position.

10. The lighting device of claim 1, further comprising a resistor disposed within the housing and electrically connected between the battery and the light emitting element.

11. The lighting device of claim 1, wherein the light emitting element comprises a light emitting diode.

12. A lighting device, comprising:
a housing;
a battery disposed within the housing;
a light emitting element supported by the housing;
a switch for opening and closing an electrical current path between the battery and the light emitting element; and
a magnet supported by the housing for magnetically securing the lighting device to a ferrous metal object,
wherein the magnet is longitudinally moveable relative to the housing such that movement of the magnet to a first position causes the switch to open the electrical current path and movement of the magnet to a second position causes the switch to close the electrical current path.

13. The lighting device of claim 12, further comprising a battery housing that at least partially surrounds the battery within the housing.

14. The lighting device of claim 12, further comprising a carriage attached to the magnet between the magnet and the battery.

15. The lighting device of claim 14, wherein the switch includes a sliding element that moves between an open-switch position that blocks electrical current from flowing between the light emitting element and the battery, and a closed-switch position that allows electrical current to flow between the light emitting element and the battery.

16. The lighting device of claim 15, wherein the carriage is attached to the sliding element of the switch such that movement of the magnet can cause the sliding element to move between the open-switch position and the closed-switch position.

17. The lighting device of claim 12, further comprising a resistor disposed within the housing and electrically connected between the battery and the light emitting element.

18. The lighting device of claim 12, wherein the light emitting element comprises a light emitting diode.

19. A lighting device, comprising:
a housing;
a battery disposed within the housing;
a light emitting element extending from a first end of the housing;
a switch extending from a second end of the housing opposite the first end of the housing, the switch being longitudinally movable by a user for opening and closing an electrical current path between the battery and the light emitting element; and
a magnet supported by the housing and extending between the first and second ends of the housing, the magnet being suitable for magnetically securing the lighting device to a ferrous metal object,
wherein at least one of the housing and the magnet includes a recess that extends between the first and second ends of the housing.

20. The lighting device of claim 19, further comprising:
a resistor disposed within the housing and electrically connected between the battery and the light emitting element; and
a battery housing that at least partially surrounds the battery within the housing, wherein the light emitting element comprises a light emitting diode.
